(19) United States
(12) Patent Application Publication
(10) Pub. No.: US 2023/0256661 A1
(43) Pub. Date: Aug. 17, 2023

(54) TWO-PART MASTERBATCH, PACKAGING ARTICLES, AND METHODS

(71) Applicant: SWIMC LLC, Cleveland, OH (US)

(72) Inventors: Rob JENKINS, Liverpool (GB); Raffaele MARTINONI, Wolfhausen (CH)

(21) Appl. No.: 18/018,419

(22) PCT Filed: Jul. 26, 2021
(86) PCT No.: PCT/US2021/043222

§ 371 Date: Jan. 27, 2023

Related U.S. Application Data
(60) Provisional application No. 63/107,808, filed on Oct. 30, 2020.
(60) Provisional application No. 63/068,964, filed on Aug. 21, 2020.
(60) Provisional application No. 63/056,963, filed on Jul. 27, 2020.

(51) Int. Cl. B29C 49/00

(52) U.S. Cl. CPC B29C 49/0005; B29C 2949/0715; B29C 2949/3028; B29K 2009/06

(57) ABSTRACT

A two-part masterbatch comprising: a first part comprising an unsaturated thermoplastic polymer, wherein the first part (typically, the unsaturated thermoplastic polymer of the first part) has an iodine value of at least 10; and a second part comprising an oxygen scavenging catalyst; packaging articles (e.g., preforms and plastic containers), and methods.

### CROSS-REFERENCE TO RELATED APPLICATION

This application claims the benefit of U.S. Provisional Patent Application No. 63/056,963, filed Jul. 27, 2020, U.S. Provisional Patent Application No. 63/068,964, filed Aug. 21, 2020, and U.S. Provisional Patent Application No. 63/107,808, filed Oct. 30, 2020, each of which is incorporated herein by reference in its entirety.

### BACKGROUND

15 Many packaged products, particularly food and beverage products, are susceptible to deterioration due to oxygen and/or moisture absorption or loss through the wall of the package. Therefore, containers, either rigid, semirigid, flexible, lidded, collapsible, or a combination thereof, not only serve as a package for the product, but also help prevent the ingress of undesirable substances from the environment.

Atmospheric oxygen is one of the most reactive substances with products packaged in a container. Molecular oxygen (O₂) is reduced to various highly reactive intermediate species by the addition of one to four electrons. The carbon-carbon double bonds present in virtually all foods and beverages are particularly susceptible to reaction with these reactive intermediate species. The resulting oxidation products adversely affect the performance, odor, and/or flavor of the product.

“Oxygen sensitive” materials, including foods, beverages, and pharmaceutical products, have special packaging requirements including preventing the ingress of exterior oxygen into the package and/or scavenging of oxygen that is present inside the package (e.g., in a headspace). In some cases, particularly in the orange juice and brewing industries, oxygen is removed from the product by vacuum, inert gas sparging, or both. However, it is difficult and expensive to remove the last traces of oxygen by these methods.

Polyethylene terephthalate (PET) has made significant inroads into bottling and packaging applications at the expense of the use of glass containers but primarily in applications where the needs for barrier properties are modest. A significant example is the use of PET for soft drink bottles; however, PET barrier properties have limited its use in the packaging of oxygen sensitive drinks such as fruit juices and beer.

Incorporation of an active oxygen scavenger into the walls of a bottle provides a very effective means for elimination of, or at least control of, the amount of oxygen which reaches the cavity of the package. There are some exacting demands which are placed upon the active oxygen scavenging walls of the bottle. One consideration is that the relatively thin walls of the bottle should be of sufficient strength and rigidity to withstand the rigors of filling, shipping, and use by consumers. The oxygen scavenging capacity of the bottle walls should be of sufficient capacity to allow for adequate shelf life and normal product turnover intervals. Shelf life and turnover intervals require that the oxygen scavenging should occur for extended periods of time. Most packaged products are stored and transported at room temperature or under refrigeration which mandates the necessity for oxygen scavenging activity at these temperatures. In those applications requiring clarity, the packaging article should have optical properties approaching those of PET. Finally, the preferred thin walled bottles should be suitable for recycle with other polyester bottles. In order to be meaningful, the recycling must be conducted without the need for any special physical or chemical processing. What is still needed are oxygen scavenging compositions for use in packaging articles (e.g., plastic containers such as plastic bottles) so as to satisfy many, if not all, of these demands.

### SUMMARY OF THE DISCLOSURE

The present disclosure provides a two-part masterbatch for making a packaging article, as well as packaging articles (e.g., plastic containers such as plastic bottles or plastic trays, preforms thereof, as well as plastic wraps and plastic films such as container cover films), and methods. To facilitate packaging article manufacture and recycling, the masterbatch includes a thermoplastic polymer.

In one embodiment, there is provided a two-part masterbatch comprising: a first part comprising an unsaturated thermoplastic polymer, wherein the first part (typically, the unsaturated thermoplastic polymer of the first part) has an iodine value of at least 10 (or at least 15, or at least 20); and a second part comprising an oxygen scavenging catalyst; wherein the first and second parts are each in the form of separate solid particles, or the first part is in the form of solid particles and the second part is in the form of a liquid, and the first and second parts are combined in a masterbatch for forming a packaging article.

In another embodiment, a preform formed from the two-part masterbatch is provided. In another embodiment, a plastic container formed from the preform is provided.

Methods are also provided.

In one method, there is provided a method of making a two-part masterbatch as described herein, the method comprising: providing a first part comprising an unsaturated thermoplastic polymer, wherein the first part (typically, the unsaturated thermoplastic polymer of the first part) has an iodine value of at least 10; forming solid particles (e.g., pellets) out of the first part; providing a second part comprising an oxygen scavenging catalyst; and forming solid particles (e.g., pellets) or a liquid out of the second part; combining the first and second parts to form a masterbatch for forming a packaging article.

In another method, there is provided a method of causing a packaging article to be made, the method comprising: providing a two-part masterbatch as described herein; causing the masterbatch to be combined with a polyester diluent to form a mixture; causing the mixture of the masterbatch and polyester diluent to be heated to a temperature of 250° C. to 290° C.; causing the heated mixture to form a preform, free-standing film, or sheet; and causing the preform, film, or sheet to be blown and/or stretched to form a packaging article.

In yet another method, there is provided a method of making a packaging article, the method comprising: providing a two-part masterbatch as described herein; combining the masterbatch with a polyester diluent to form a mixture; heating the mixture of the masterbatch and polyester diluent to a temperature of 250° C. to 290° C.; forming a preform, free-standing film, or sheet out of the heated mixture; blowing and/or stretching the preform, film, or sheet to form a packaging article.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “thermoplastic” polymer refers to a material that melts and changes shape when sufficiently heated and hardens when sufficiently cooled. Such materials are typically capable of undergoing repeated melting and hardening without exhibiting appreciable chemical change. In contrast, a “thermoset” polymer refers to a material that is crosslinked and does not “melt.”

The term “packaging article” as used herein includes both packaging articles in their final commercial form, as well as intermediate stages. Preforms, which are frequently formed for plastic containers and other packaging articles, are one example of such an intermediate stage. The term includes at least free-standing films, wraps, bottles, trays, containers, closures, closure liners, etc.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

As used herein, the term “room temperature” refers to a temperature of 20° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE FIGURES

FIG. 1 is a cross-sectional view of a preform according to this disclosure.

FIG. 2 is an elevational view of a plastic container according to this disclosure

### DETAILED DESCRIPTION OF ILLUSTRATIVE EMBODIMENTS

The present disclosure provides a two-part masterbatch, packaging articles made from the masterbatch (e.g., plastic containers such as plastic bottles or plastic trays, preforms thereof, as well as plastic wraps and plastic films such as container cover films), and methods. Such packaging articles are typically used for packaging oxygen-sensitive products. Preferred packaging articles include plastic containers such as a plastic bottle and a preform thereof. The masterbatch includes a first part including an unsaturated polymer, and a second part including an oxygen scavenging catalyst.

More specifically, the two-part masterbatch includes at least two distinct parts. The first part includes an unsaturated thermoplastic polymer, wherein the first part (typically, the unsaturated thermoplastic polymer of the first part) has an iodine value of at least 10, and the second part includes an oxygen scavenging catalyst. These parts are combined to form a masterbatch, which is then used to form a packaging article. In one exemplary embodiment, the first and second parts are each in the form of separate solid particles, and in another exemplary embodiment, the first part is in the form of solid particles and the second part is in the form of a liquid. The two parts may be separately packaged and provided, e.g., in a kit, or the two parts may be packaged together and provided, e.g., as a physical mixture. The masterbatch is processed (e.g., by injection molding), typically with other materials such as a polyester diluent, under conditions effective to form a packaging article.

Herein, a “two-part” masterbatch typically includes two parts—one including the unsaturated polymer and one including the oxygen scavenging catalyst—but there may be one or more other parts, e.g., that include optional additives. For example, an antistat that is external to both the first and second parts, which are both in the form of pellets, may be used to assist in blending the two sets of pellets.

The first part is in the form of solid particles (e.g., pellets or granules).

The second part may be in the form of solid particles or, it may be in the form of a liquid. The liquid form of the second part can result from dissolving/dispersing the oxygen scavenging catalyst in, e.g., mineral oil, triglyceride oil, or a low molecular weight ester. The solid form of the second part may be in the form of solid particles with the oxygen scavenging catalyst blended with a polyester (e.g., PET).

Herein, the solid particles may be in the form of pellets or granules, for example. Such particles may be in a variety of sizes. For example, in certain embodiments, a particle size (i.e., the longest dimension of the particle) may be approximately 3 mm in length.

In certain embodiments, the first and second parts are each in the form of separate solid particles. In this context, “separate solid particles” means that the components of the first part form one set of solid particles and the components of the second part form a distinct set of solid particles, which particles may be physically blended together if desired; however, the components of the two parts are not intimately mixed together such that they react with each other prior to forming a packaging article (e.g., a plastic container preform). A physical mixture of each of the (at least) two parts can be considered a “salt and pepper” masterbatch.

In certain embodiments, the first part and the second part are often combined in a weight ratio of 1:99 to 99:1, 10:90 to 90:10, 20:80 to 80:20, 30:70 to 70:30, or 40:60 to 60:40.

In certain embodiments, the masterbatch is storage stable under ambient conditions (e.g., when stored in the presence of ambient 25° C. atmospheric air at 50% relative humidity). That is, certain embodiments are storage stable without the need for storing under nitrogen. This is particularly true (and advantageous) of the “salt and pepper” masterbatch that includes a blend of pellets or granules of both parts.

In certain embodiments, the masterbatch includes less than 5 wt-% (or less than 1 wt-%, less than 0.5 wt-%, or less than 0.1 wt-%) of nylon-MXD6 (or any type of nylon, generally), if any. Although small amounts of nylon-MXD6 can provide passive barrier properties to plastic containers, eliminating MXD6 enhances the recycling properties of the resultant plastic containers. Nylon-MXD6 is a generic name given to a wide range of polyamides produced from m-xylenediamine (MXDA) by Mitsubishi Gas Chemical Co., Ind. It is a crystalline polyamide produced by polycondensation of MXDA with adipic acid. Different from Nylon 6 and Nylon 66, Nylon-MXD6 is an aliphatic polyamide containing an aromatic ring in its main chain. See the chemical configuration shown below.

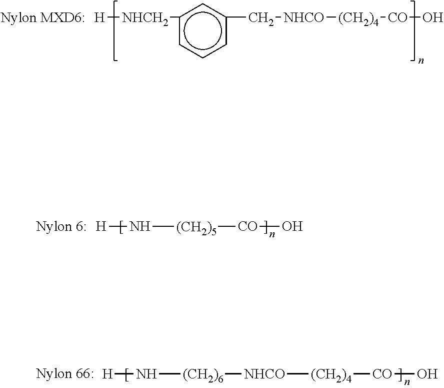

### Unsaturated Polymer (Part One)

The first part includes an unsaturated polymer. The unsaturation (e.g., double bonds, triple bonds) in the first part reacts with oxygen and acts as an oxygen scavenger. Thus, the unsaturated polymer may be referred to as an oxygen-scavenging polymer.

The first part, typically, the unsaturated polymer in the first part, has an iodine value of at least 10, at least 15, or at least 20. In this context, “Iodine Value” is expressed in terms of centigrams of iodine per gram of resin, and is determined using ASTM D 5758-02 (Reapproved 2006) entitled “Standard Method for Determination of Iodine Values of Tall Oil Fatty Acids.” In the context of the first part having a particular iodine value, this refers to the centigrams of iodine per gram of first part material. Iodine value is a useful measure for characterizing the average number of double bonds present in a material.

The unsaturated polymer of the disclosure can be of any suitable size. In preferred embodiments, the unsaturated polymer has a number average molecular weight (Mn) of at least 1,000, more preferably at least 2,000, even more preferably at least 5,000, and even more preferably at least 25,000. Preferably, the unsaturated polymer has a Mn of less than 100,000, more preferably less than 50,000, and even more preferably less than 35,000.

The unsaturated polymer is a thermoplastic polymer that can be formed or shaped (e.g., into a three-dimensional article or free-standing film) by processes such as, for example, injection molding, extrusion, pressing, casting, rolling, or molding.

In certain embodiments, the unsaturated thermoplastic polymer of the first part (with an iodine value of at least 10) is a polyester copolymer including unsaturated units. In this context, unsaturated units refer to structural units derived from aliphatic unsaturated compounds. In this context, structural units derived from terephthalic acid, isophthalic acid, or the like, are not unsaturated units (aromatic double bonds do not register in the iodine value test).

Unsaturated units can be derived from ethylenically unsaturated hydrocarbons, such as those described in U.S. Pat. No. 5,399,289 (Speer et al.). Unsaturated cyclic or polycyclic compounds (e.g., cyclohexene or norbornene) can also form the unsaturated units of the copolymer. As for norbornene groups, they can be brought into the polymer, e.g., using nadic acid or anhydride or by reacting in maleic anhydride or another unsaturated monomer capable of incorporating into a polyester and then doing a Diels-Alder reaction using DCPD (dicyclopentadiene) to form the norbornene group in situ. Suitable oxygen-scavenging polymers containing norbornene groups, for example, are described in U.S. Pat. No. 8,758,644 (Share et al).

The unsaturation is typically in the form of a double bond. Examples of suitable double bonds include carbon-carbon, carbon-oxygen, carbon-nitrogen, nitrogen-nitrogen, or nitrogen-oxygen, with C═C bonds being preferred.

Preferably, the unsaturated polyester copolymer includes unsaturated olefin structural units (typically backbone segments).

In certain embodiments, the polyester copolymer that includes unsaturated olefin structural units may be made by compounding or blending a polyester and an olefin or a polyolefin. In such embodiments, the first part may include the copolymer as well as a polyester and a polyolefin. Typically, the copolymer functions as a compatibilizer that assists in intimately mixing the polymers (i.e., the polyester and the polyolefin) in the melt phase. In some embodiments, the copolymer is formed via melt-blending the polyester and polyolefin together in the presence of a transesterification catalyst, which is preferably a transesterification catalyst that does not appreciably function as an oxidative catalyst, to preserve storage stability and oxygen-scavenging capacity.

In certain embodiments, the polyester copolymer that includes unsaturated olefin structural units may be made by grafting unsaturated olefin structural units onto a polyester chain.

Polyesters suitable for making a polyester copolymer including unsaturated units include a polyethylene terephthalate (“PET”), a polyethylene terephthalate isophthalic acid copolymer (“PET-I”), polybutylene terephthalate (“PBT”), polycyclohexane terephthalate, polyethylene naphthalate (“PEN”), polybutylene naphthalate (“PBN”), cyclohexane dimethanol/polyethylene terephthalate copolymer (“PET-G”), or a copolymer or mixture thereof. In certain embodiments, the polyester is polyethylene terephthalate, polyethylene naphthalate, or a copolymer or mixture thereof. In certain preferred embodiments, the polyester is polyethylene terephthalate or a copolymer thereof.

Other polyesters suitable for making a polyester copolymer including unsaturated units include those described in U.S. Pat. No. 8,192,676 (Share et al.), International Publication Nos. WO 98/12244 (Amoco Corp.), and U.S. Pat. No. 8,476,400 (Joslin et al.).

In certain embodiments, the polyester copolymer may be formed from various difunctional components, such as isophthalic acid (IPA), terephthalic acid (TPA), ethylene glycol, 1-butanediol (BDO), with an olefin or a polyolefin (e.g., hydroxyl-terminated polybutadiene, “HTPB”) added during esterification and/or condensation. Commercially available polybutadienes are readily available, such as that available under the tradename KRASOL by Cray Valley.

In certain embodiments, the polyester copolymer that includes unsaturated olefin structural units may be derived from an olefin or a polyolefin selected from butadiene, polybutadiene, and a mixture thereof. In certain embodiments, the olefin structural units are derived from polybutadiene. Exemplary polyolefins, particularly polybutadiene, are described in International Publication No. WO 98/12244 (Amoco Corp.). A preferred polyolefin starting material is dihydroxy terminated polybutadiene (HTPB), but anhydride terminated may also be suitable. In certain embodiments, the polyolefin has a molecular weight of 100 Daltons to 10,000 Daltons.

In certain embodiments, the unsaturated polymer of the first part is derived from an olefin or a polyolefin in an amount of at least 0.5 wt-% (at least 2 wt-%, or at least 5 wt-%), based on the weight of the first part. In certain embodiments, the unsaturated polymer of the first part is derived from an olefin or a polyolefin in an amount of up to 25 wt-% (or up to 12 wt-%, or up to 8 wt-%), based on the weight of the first part.

In certain embodiments, the unsaturated polymer of the first part is derived from a polyester in an amount of at least 75 wt-% (or at least 88 wt-%, or at least 92 wt-%), based on the weight of the first part. In certain embodiments, the unsaturated polymer of the first part is derived from a polyester in an amount of up to 99.5 wt-% (or up to 98 wt-%, or up to 95 wt-%), based on the weight of the first part.

In certain embodiments, the first part further includes a non-cobalt-containing esterification catalyst. The esterification catalyst used in the first part is not an oxygen scavenger under typical process conditions used during formation of the first part. Examples of non-cobalt-containing esterification catalysts include titanium, antimony, tin, a mineral acid, a salt thereof (e.g., an organometallic salt), or a mixture thereof.

In certain embodiments, the unsaturated polymer is present in the first part in an amount of at least 25 wt-% (or at least 30 wt-%), based on the weight of the first part. In certain embodiments, the unsaturated polymer is present in an amount of up to 100 wt-% (or up to 75 wt-%, or up to 70 wt-%), based on the weight of the first part. If the first part includes 100% of the unsaturated polymer, the pellets of the first part are neat.

The first part may include the unsaturated thermoplastic polymer neat (100 wt-%), which is then combined with the second part to form an oxygen-scavenging layer of a monolayer or multilayer packaging article. Or, alternatively, prior to formation of the oxygen-scavenging layer of the packaging article, it can be blended with one more additional polymers or additives, which may, for example, reduce transportation and storage costs and/or help preserve the oxygen-scavenging capacity of the unsaturated polymer of the first part. Such additional polymers or additives are preferably compatible with the unsaturated thermoplastic polymer of the first part. For example, polymers having similar physical properties such as a viscosity and glass-transition temperature (“T_{g}”) may be used in conjunction with unsaturated thermoplastic polymer of the first part.

### Oxygen Scavenging Catalyst (Part Two)

An “oxygen scavenger” or “oxygen scavenging” catalyst is a compound that can enhance the oxygen scavenging properties of the unsaturated polymer of the first part. While not being bound by theory, the catalyst is believed to assist in activating the unsaturation (e.g., double bonds) of the unsaturated polymer to facilitate an interaction with oxygen. For example, it may catalyze an oxygen-scavenging reaction that removes oxygen from the interior of a closed package, or prevents oxygen from entering the interior of the package, either by reacting or combining with the entrapped oxygen, or by promoting an oxidation reaction that yields innocuous products. This scavenging effect confers high oxygen barrier properties to the packaging article.

In certain embodiments, the oxygen scavenging catalyst includes a metal, a complex of a metal (e.g., an organometallic catalyst comprising a transition metal), or a salt of a metal. A transition-metal-containing catalyst is preferred, with a cobalt-containing catalyst being particularly preferred.

Examples of metals include iron, cobalt, copper, manganese, nickel, ruthenium, rhodium, palladium, osmium, iridium, and platinum. Other suitable oxygen scavenging catalysts include aluminum powder, aluminum carbide, aluminum chloride, cobalt powder, cobalt oxide, cobalt chloride, antimony powder, antimony oxide, antimony triacetate, antimony chloride III, antimony chloride V, iron, electrolytic iron, iron oxide, platinum, platinum on alumina, palladium, palladium on alumina, ruthenium, rhodium, copper, copper oxide, nickel, and mixed metal nanoparticles (e.g., cobalt iron oxide nanoparticles). A cobalt, iron, nickel, copper, or manganese compound is a preferred oxygen scavenging catalyst.

A cobalt compound is most preferred. Typically, the oxygen scavenging catalyst is present as a salt or a complex of a metal. The anion of the salt can be inorganic or organic. Examples of anions include halide, especially chloride, acetate, stearate, and octoate. Other oxygen scavenging agents include cobalt (II) bromide and cobalt carboxylate. Cobalt carboxylate is available as cobalt SICCATOL (trademark of Akzo Chemie Nederland B.V., Amersford, Netherlands). A cobalt carboxylate is a solution of C₈-C₁₀ cobalt carboxylates and the concentration of cobalt (as metal) is about 10%, by weight, relative to the solution.

In certain embodiments, a masterbatch of the present disclosure includes one or more oxygen scavenging catalyst(s) in an amount of at least 20 ppm (metal only), based on the total weight of the first and second parts. In certain embodiments, a masterbatch of the present disclosure includes one or more oxygen scavenging catalyst(s) in an amount of up to 2000 ppm (metal only), based on the total weight of the first and second parts. In the aforementioned, the phrase “metal only” does not exclude the presence of other material in the catalyst such as anions, but rather is used to indicate that the indicated concentration is only based on the amount of metal present in the catalyst.

Although cobalt is a preferred component of the second part, preferably little or no cobalt is in the first part. In certain embodiments, the first part includes less than 50 ppm cobalt (or less than 30 ppm, less than 20 ppm, less than 10 ppm, less than 1 ppm, or less than 0.1 ppm), if any (i.e., none is intentionally added to the first part). Prior processes have used cobalt carboxylic acid as an esterification catalyst (in the first part); however, this is undesirable because it can increase homopolymerization of the olefin due to acceleration of free-radical polymerization, it can increase haze/turbidity in the resultant plastic container, and the homopolymerized olefin can reduce oxygen scavenging capacity of the plastic container. Also, avoiding the use of cobalt in the first stage reduces the need for nitrogen purging during use.

### Optional Additives

The two-part masterbatch may include one or more optional additives that do not adversely affect the masterbatch or the packaging articles (e.g., the preforms, or the plastic containers) formed therefrom.

For example, the masterbatch may be combined with a polyester diluent. Or, the second part of the two-part masterbatch may further include a polyester (e.g., PET) diluent to dilute the oxygen scavenging catalyst(s) in the second part, in an amount desired by one skilled in the art.

The second part may also include a solvent or dispersant for dissolving/dispersing the oxygen scavenging catalyst. Examples include mineral oil, triglyceride oil, or a low molecular weight ester, which may be used in various combinations.

The first part of the two-part masterbatch may include an oxygen scavenging dendritic or hyperbranched polymer if desired (but not the catalyst as described above). Exemplary such polymers are described in U.S. Pat. No. 8,476,400 (Joslin et al.). This oxygen scavenging dendritic or hyperbranched polymer could be in the first part, but typically not the second part.

The first part of the two-part masterbatch may further include a polycondensate branching agent. Exemplary polycondensate branching agents include a trimellitic anhydride, an aliphatic dianhydride, an aromatic dianhydride, or a mixture thereof. Pyromellitic dianhydride (PMDA) is an especially preferred branching agent because it reacts quickly and to completion with polycondensates and also because it is readily commercially available. When used, these branching agents are normally employed in the extruder in an amount sufficient to obtain the desired intrinsic viscosity of the copolycondensates, typically in amounts up to 5,000 ppm (0.5%) with a preferred range of 0 to 3,000 ppm.

The first part may also further include an antioxidant that also optionally (and preferably) functions as an olefin homopolymerization preventative. An example of such compounds include hypophosphorous acid, phosphoric acid, or salts thereof. Hypophosphorous acid, i.e., phosphinic acid, is preferred. It is a phosphorus oxyacid and a powerful reducing agent with molecular formula H₃PO₂. It is a colorless low-melting compound, which is soluble in water, dioxane, and alcohols. It aids in grafting a polyolefin (e.g., hydroxyl-terminated polybutadiene, “HTPB”) onto a polyester (e.g., PET) polymer backbone. Such antioxidant (and, preferably, olefin homopolymerization preventative) can be included in an amount of at least 0.1 wt-%, based on total weight of the first part. When used, the antioxidant will typically be included in an amount of less than 1 wt-%, based on total weight of the first part.

Another optional additive for the first part of the two-part masterbatch may be an emulsifier. Examples include alkali metal carboxylates, such as calcium and magnesium salts.

In certain embodiments, the masterbatch may further include (in either the first or the second part, or in one or more other parts) an additive selected from an antistat (e.g., an ethoxylated triglyceride oil), a stabilizer, an extrusion aid, a drying agent, a filler, an anticlogging agent, a crystallization aid, an impact modifier, a die, a pigment, and a mixture thereof. Other examples of additives, and suitable amounts, are described in U.S. Pat. No. 8,476,400 (Joslin et al.).

### Packaging Articles

The two-part masterbatch is designed for use in forming a packaging article that are typically used for packaging oxygen-sensitive products.

In a preferred embodiment, the two-part masterbatch is used to form a preform (i.e., a plastic container preform). In certain embodiments, the two-part masterbatch is used in an amount of 1 wt-% to 6 wt-% of the preform weight. The remainder of the preform is typically a polyester (e.g., PET), which may be recycled or virgin polyester.

Such preforms may be used to form a plastic container, which may be a plastic bottle or a food tray, for example. The plastic containers may be monolayer or multilayer. For example, in one embodiment, the plastic container is a monolayer plastic container (e.g., a clear monolayer beverage container), and in another embodiment, the plastic container is a multilayer plastic container (e.g., a clear monolayer beverage container).

Preferably, plastic containers made using the masterbatches of the present disclosure have desirable clarity and low haze. For example, plastic containers of the present disclosure have similar clarity (i.e., within 90% of the clarity, and often less haze) than that of a clear plastic beverage bottle (e.g., a clear screw-top 16.9 or 24 ounce size beverage bottle) made the same way without the masterbatch and only virgin PET.

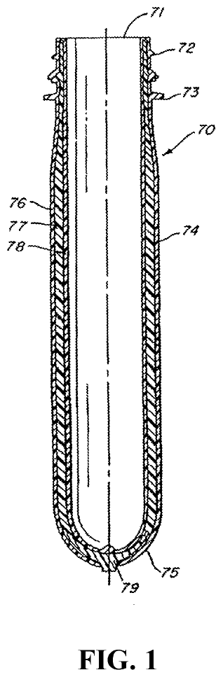

FIG. 1 shows an exemplary preform 70 having an open upper end 71 with a neck finish including outer threads 72 and a cylindrical flange 73. Below the neck flange there is a substantially cylindrical body portion 74, terminating in a closed hemi spherical bottom end 75. The sidewall is a three-layer sidewall construction, which includes outer layer 76, core layer 77, and inner layer 78. By way of example, the inner and outer (exterior) layers (78 and 76) may be virgin bottle grade PET, while the core layer 77 comprises a blend (e.g., material formed from the two-part masterbatch described herein). In a lower base-forming portion of the preform, a five-layer structure may optionally be formed by a last shot of virgin PET that clears the injection nozzle of the blend composition (so it is filled with virgin PET for preparation of the next preform). The last shot 79 of virgin PET forms a five-layer structure around the gate, and in this case the virgin PET extends through to the exterior of the preform at the gate region. The dimensions and wall thicknesses of the preform shown in FIG. 1 are not to scale. Any number of different preform constructions may be used.

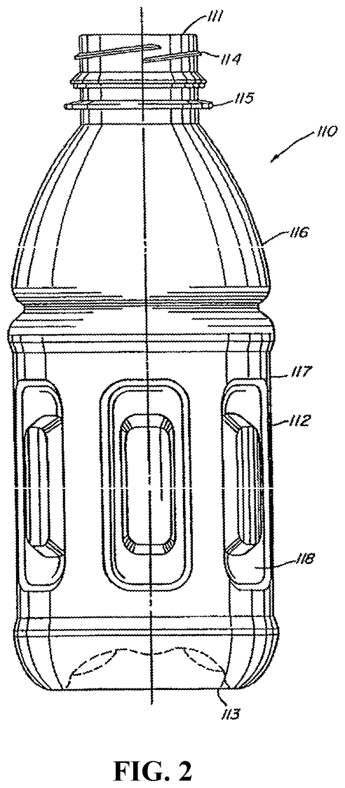

FIG. 2 shows a representative plastic container that may be blow molded from a preform similar to that shown in FIG. 1. The container 110 includes an open top end 111, substantially cylindrical sidewall 112, and closed bottom end 113. The container includes the same neck finish 114 and flange 115 of the preform, which are not expanded during blow molding. The sidewall includes an expanded shoulder portion 116 increasing in diameter to a cylindrical panel portion 117, which includes a plurality of vertically elongated, symmetrically disposed vacuum panels 118. The vacuum panels are designed to move inwardly to alleviate the vacuum formed during product cooling in the sealed container. Again, this container construction is by way of example only and the invention is not limited to any particular package structure.

### Methods

Methods of making the masterbatch of the present disclosure, methods of making a packaging article (e.g., a plastic container), and methods of causing a packaging article (e.g., a plastic container) to be made are provided.

In one method, there is provided a method of making a two-part masterbatch as described herein, the method comprising: providing a first part comprising an unsaturated thermoplastic polymer, wherein the first part (typically, the unsaturated thermoplastic polymer of the first part) has an iodine value of at least 10; forming solid particles (e.g., pellets) out of the first part; providing a second part comprising an oxygen scavenging catalyst; and forming solid particles (e.g., pellets) or a liquid out of the second part; combining the first and second parts to form a masterbatch for forming a packaging article. The masterbatch may be in the form of a physical mixture of the two parts (e.g., in the form of pellets or granules) that may be packaged together, or it may be in the form of separately packaged parts (e.g., in the form of pellets or granules and a liquid) in a kit. The first and second parts are combined and processed (e.g., by injection molding) under conditions effective to form a packaging article.

In another method, there is provided a method of causing a packaging article to be made, the method comprising: providing a two-part masterbatch as described herein; causing the masterbatch to be combined with a polyester diluent to form a mixture; causing the mixture of the masterbatch and polyester diluent to be heated to a temperature of 250° C. to 290° C.; causing the heated mixture to form a preform, free-standing film, or sheet; and causing the preform, film, or sheet to be blown and/or stretched to form a packaging article.

In yet another method, there is provided a method of making a packaging article, the method comprising: providing a two-part masterbatch as described herein; combining the masterbatch with a polyester diluent to form a mixture; heating the mixture of the masterbatch and polyester diluent to a temperature of 250° C. to 290° C.; forming a preform, free-standing film, or sheet out of the heated mixture; blowing and/or stretching the preform, film, or sheet to form a packaging article.

### Exemplary Embodiments

Embodiment 1 is a two-part masterbatch comprising: a first part comprising an unsaturated thermoplastic polymer, wherein the first part (typically, the unsaturated thermoplastic polymer of the first part) has an iodine value of at least 10 (or at least 15, or at least 20); and a second part comprising an oxygen scavenging catalyst; wherein the first and second parts are each in the form of separate solid particles, or the first part is in the form of solid particles and the second part is in the form of a liquid, and the first and second parts are combined in a masterbatch for forming a packaging article.

Embodiment 2 is the masterbatch of embodiment 1 which is storage stable under ambient conditions (e.g., when stored in the presence of ambient 25° C. atmospheric air at 50% relative humidity). Embodiment 3 is the masterbatch of embodiment 1 or 2 wherein the unsaturated polymer of the first part comprises a polyester copolymer including unsaturated units. Embodiment 4 is the masterbatch of embodiment 3 wherein the unsaturated polymer of the first part comprises a polyester copolymer including unsaturated olefin structural units (typically backbone segments). Embodiment 5 is the masterbatch of embodiment 4 wherein the first part further comprises a polyester and a polyolefin. Embodiment 6 is the masterbatch of embodiment 4 wherein the first part comprises unsaturated olefin structural units grafted onto a polyester chain.

Embodiment 7 is the masterbatch of any one of embodiments 3 through 6 wherein the first part comprises a polyester copolymer formed from various difunctional components, such as isophthalic acid (IPA), terephthalic acid (TPA), ethylene glycol, 1-butanediol, with a polyolefin (e.g., hydroxyl-terminated polybutadiene, “HTPB”) added during esterification and/or condensation.

Embodiment 8 is the masterbatch of any one of the previous embodiments wherein the first part further comprises a non-cobalt-containing esterification catalyst. Embodiment 9 is the masterbatch of embodiment 8 wherein the non-cobalt-containing esterification catalyst comprises titanium, antimony, tin, a mineral acid, a salt thereof (e.g., an organometallic salt), or a mixture thereof.

Embodiment 10 is the masterbatch of any one of embodiments 3 through 9 wherein the polyester copolymer including unsaturated olefin units comprises a polyester selected from polyethylene terephthalate (“PET”), a polyethylene terephthalate isophthalic acid copolymer (“PET-I”), polybutylene terephthalate (“PBT”), polycyclohexane terephthalate, polyethylene naphthalate (“PEN”), polybutylene naphthalate (“PBN”), cyclohexane dimethanol/polyethylene terephthalate copolymer (“PET-G”), or a copolymer or mixture thereof. Embodiment 11 is the masterbatch of embodiment 10 wherein the polyester is selected from polyethylene terephthalate, polyethylene naphthalate, or a copolymer or mixture thereof. Embodiment 12 is the masterbatch of embodiment 11 wherein the polyester is selected from polyethylene terephthalate or a copolymer thereof.

Embodiment 13 is the masterbatch of any one of the previous embodiments wherein the first part comprises the unsaturated polymer in an amount of at least 25 wt-% (or at least 30 wt-%), based on the weight of the first part. Embodiment 14 is the masterbatch of embodiment 13 wherein the first part comprises the unsaturated polymer in an amount of up to 100 wt-% (or up to 75 wt-%, or up to 70 wt-%), based on the weight of the first part.

Embodiment 15 is the masterbatch of any one of the previous embodiments wherein the unsaturated polymer comprises olefin structural units derived from an olefin or a polyolefin selected from butadiene, polybutadiene, and a mixture thereof. Embodiment 16 is the masterbatch of embodiment 15 wherein the olefin structural units are derived from polybutadiene. Embodiment 17 is the masterbatch of embodiment 15 or 16 wherein the polyolefin has a molecular weight of 100 Daltons to 10,000 Daltons.

Embodiment 18 is the masterbatch of any one of the previous embodiments wherein the unsaturated polymer of the first part is derived from an olefin or a polyolefin in an amount of at least 0.5 wt-% (at least 2 wt-%, or at least 5 wt-%), based on the weight of the first part. Embodiment 19 is the masterbatch of any one of the previous embodiments wherein the unsaturated polymer of the first part is derived from an olefin or a polyolefin in an amount of up to 25 wt-% (or up to 12 wt-%, or up to 8 wt-%), based on the weight of the first part. Embodiment 20 is the masterbatch of any one of the previous embodiments wherein the unsaturated polymer of the first part is derived from a polyester in an amount of at least 75 wt-% (or at least 88 wt-%, or at least 92 wt-%), based on the weight of the first part. Embodiment 21 is the masterbatch of embodiment 20 wherein the unsaturated polymer of the first part is derived from a polyester in an amount of up to 99.5 wt-% (or up to 98 wt-%, or up to 95 wt-%), based on the weight of the first part.

Embodiment 22 is the masterbatch of any one of the previous embodiments wherein the oxygen scavenging catalyst comprises a metal, a complex of a metal (e.g., an organometallic catalyst comprising a transition metal), or a salt of a metal. Embodiment 23 is the masterbatch of any one of the previous embodiments wherein the oxygen scavenging catalyst comprises a transition-metal-containing catalyst, with a cobalt-containing catalyst being preferred. Embodiment 24 is the masterbatch of any one of the previous embodiments wherein the oxygen scavenging catalyst is present in an amount of at least 20 ppm (metal only), based on the total weight of the first and second parts. Embodiments 25 is the masterbatch of any one of the previous embodiments wherein the oxygen scavenging catalyst is present in an amount of up to 2000 ppm (metal only), based on the total weight of the first and second parts.

Embodiment 26 is the masterbatch of any one of the previous embodiments wherein the second part further comprises a polyester (e.g., PET).

Embodiment 27 is the masterbatch of any one of the previous embodiments wherein the first part further comprises an oxygen scavenging dendritic or hyperbranched polymer.

Embodiment 28 is the masterbatch of any one of the previous embodiments wherein the first part further comprises a polycondensate branching agent. Embodiment 29 is the masterbatch of embodiment 28 wherein the polycondensate branching agent comprises trimellitic anhydride, an aliphatic dianhydride, an aromatic dianhydride, or a mixture thereof.

Embodiment 30 is the masterbatch of any one of the previous embodiments wherein the first part further comprises an antioxidant that also optionally (and preferably) functions as an olefin homopolymerization preventative. Embodiment 31 is the masterbatch of embodiment 30 wherein the antioxidant comprises hypophosphorous acid or a salt thereof. Embodiment 32 is the masterbatch of embodiment 30 or 31 wherein the first part comprises the antioxidant in an amount of 0.1 wt-% to 1 wt-%, based on total weight of the first part.

Embodiment 33 is the masterbatch of any one of the previous embodiments wherein the first part further comprises an emulsifier.

Embodiment 34 is the masterbatch of any one of the previous embodiments which further comprises an additive selected from an antistat, a stabilizer, an extrusion aid, a drying agent, a filler, an anticlogging agent, a crystallization aid, an impact modifier, a die, a pigment, and a mixture thereof.

Embodiment 35 is the masterbatch of any one of the previous embodiments wherein the first part comprises less than 50 ppm cobalt (or less than 30 ppm, less than 20 ppm, less than 10 ppm, less than 1 ppm, or less than 0.1 ppm), if any (i.e., none is intentionally added).

Embodiment 36 is the masterbatch of any one of the previous embodiments comprising less than 5 wt-% (or less than 1 wt-%, less than 0.5 wt-%, or less than 0.1 wt-%) of nylon-MXD6, if any. Embodiment 37 is the masterbatch of any one of the previous embodiments comprising less than 5 wt-% (or less than 1 wt-%, or less than 0.5 wt-%) of nylon, if any.

Embodiment 38 is the masterbatch of any one of the previous embodiments wherein the first and second parts are each in the form of separate solid particles, and the masterbatch forms a physical mixture of each (thereby forming a “salt and pepper” masterbatch). Embodiment 39 is the masterbatch of any one of the previous embodiments comprising the first part to the second part in a weight ratio of 1:99 to 99:1, 10:90 to 90:10, 20:80 to 80:20, 30:70 to 70:30, or 40:60 to 60:40.

Embodiment 40 is a preform formed from the two-part masterbatch of any one of the previous embodiments. Embodiment 41 is the preform of embodiment 40 wherein the two-part masterbatch comprises 1 wt-% to 6 wt-% of the preform weight.

Embodiment 42 is a plastic container formed from the preform of embodiment 40 or 41. Embodiment 43 is the plastic container of embodiment 42 which is a plastic bottle or food tray. Embodiment 44 is the plastic container of embodiment 42 or 43 which is a monolayer plastic container (e.g., a clear monolayer beverage container). Embodiment 45 is the plastic container of embodiment 42 or 43 which is a multilayer plastic container (e.g., a clear monolayer beverage container). Embodiment 46 is the plastic container of any one of embodiments 42 through 45 which has similar clarity (i.e., within 90% of the clarity, and often less haze) to that of a clear plastic beverage bottle (e.g., a clear screw-top 16.9 or 24 ounce size beverage bottle) made the same way without the masterbatch and only Virgin PET.

Embodiment 47 is a method of making a two-part masterbatch of any one of embodiments 1 through 39, the method comprising: providing a first part comprising an unsaturated thermoplastic polymer, wherein the first part (typically, the unsaturated thermoplastic polymer of the first part) has an iodine value of at least 10 (or at least 15, or at least 20); forming solid particles (e.g., pellets) out of the first part; providing a second part comprising an oxygen scavenging catalyst; and forming solid particles (e.g., pellets) or a liquid out of the second part; combining the first and second parts to form a masterbatch for forming a packaging article.

Embodiment 48 is a method of causing a packaging article to be made, the method comprising: providing a two-part masterbatch of any one of embodiments 1 through 39; causing the masterbatch to be combined with a polyester diluent to form a mixture; causing the mixture of the masterbatch and polyester diluent to be heated to a temperature of 250° C. to 290° C.; causing the heated mixture to form a preform, free-standing film, or sheet; and causing the preform, film, or sheet to be blown and/or stretched to form a packaging article.

Embodiment 49 is a method of making a packaging article, the method comprising: providing a two-part masterbatch of any one of embodiments 1 through 39; combining the masterbatch with a polyester diluent to form a mixture; heating the mixture of the masterbatch and polyester diluent to a temperature of 250° C. to 290° C.; forming a preform, free-standing film, or sheet out of the heated mixture; and blowing and/or stretching the preform, film, or sheet to form a packaging article.

Embodiment 50 is the method of embodiment 48 or 49 wherein the packaging article is a plastic bottle comprising the two-part masterbatch in an amount of 0.5 wt-% to 10 wt-%, based on the final weight of the plastic bottle.

### Examples

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods. The following abbreviations may be used in the following examples: ppm=parts per million; phr=parts per hundred rubber; mL=milliliter; L=liter; m=meter, mm=millimeter, cm=centimeter, kg=kilogram, g=gram, min=minute, s=second, hrs=hour, ° C.=degrees Celsius, ° F.=degrees Fahrenheit, MPa=megapascals, and N-m=Newton-meter, Mn=number average molecular weight, cP=centipoise.

### Generic Method for Production of Exemplary Polyesters

There are two main routes for the manufacture of Polyesters: 1) Esterification/Condensation route; and 2) Transesterification route. Both can be used to make the equivalent formula or end product.

### Esterification/Condensation Routes

### Option 1

a) Charge the polyols and hydroxyl-terminated polybutadiene “HTPB” to the reactor and start mixing. Then charge the diacids, as well as any catalysts and inhibitors. Apply a nitrogen purge to lower the O₂ concentration in the reactor.
b) Heat to reflux (approximately 200-260° C.), removing the water of reaction via fractionating column. This reaction can occur at atmospheric pressure and/or under some partial pressure to aid glycol loss. The water of reaction is removed but any glycols separated are returned to the reactor.
c) Continue the above reaction and fractionation until the bulk glycols are grafted onto the polymer chain. Then switch over from a fractionating column to a standard condenser to remove water of reaction. Apply vacuum until the appropriate properties (e.g., molecular weight, melting point) are obtained. The reaction temperature may increase to 260-280° C. The resultant polymer is discharged from the reactor to form pellets.

### Option 2

a) Charge polyols and the diacids to the reactor together with the catalyst and inhibitors. Apply nitrogen and mix the contents. Heat to reflux (approximately 200-260° C.). Remove water of reaction via a fractionating column. This reaction can occur at atmospheric pressure and/or under some partial pressure to aid glycol loss. The water of reaction is removed but any glycols separated are returned to the reactor.
b) Continue the above reaction and fractionation until the bulk glycols are grafted onto the polymer chain. Then switch over from a fractionating column to a standard condenser to remove water of reaction. Charge the HTPB and possibly some catalyst and inhibitors. Apply vacuum until the appropriate properties (e.g., molecular weight, melting point) are obtained. The reaction temperature may increase to 260-280° C. The resultant polymer is discharged from the reactor to form pellets.

### Notes

a) In either of the above two routes. The second stage condensation reactor could also be carried out under azeotropic distillation using an azeotropic solvent to aid the removal of the water of reaction and also importantly help inhibit any copolymerization of the HTPB.
b) Prepolymers of diacids and polyols can be used to aid the reaction of the HTPB.
c) Acid-terminated versions of HTPB or prepolymers may be used to aid the reaction of the polybutadiene, and to minimise any copolymerisation and aid dispersion and performance as an Oxygen barrier.

d) A transesterification route could also be employed where methylated ester of IPA and TPA are reacted with Polyols and HTPB.

### Test Methods

Glass transition (Tg) is determined by using a equipment such as a Differential Scanning calorimetry (DSC) (e.g., Perkin Elmer, Mettler Toledo Equipment).

Relative or Intrinsic Viscosity can be determined using:
ASTM D 1243 Test Method for Dilute Solution Viscosity of Vinyl Chloride Polymers;
ASTM D 2857 Test Method for Standard Practice for Dilute Solution Viscosity of Polymers; or
ASTM D 4603 Test Method for Determining Inherent Viscosity of Poly(Ethylene Terephthalate) (PET) by Glass Capillary Viscometer.
Color can abe determine using a Colorimeter (such as the Xrite or Mettler type colourimeters) and a Color Analysis Test Method such as ASTM E1347 with ASTM D2244.

### Examples

The following examples are directed to the first part of a masterbatch that includes a polyester copolymer formed from various difunctional components, such as isophthalic acid (IPA), terephthalic acid (TPA), ethylene glycol (EG), 1-butanediol (BDO), with a polyolefin (e.g., hydroxyl-terminated polybutadiene, “HTPB”) added during esterification and/or condensation. Each of the following examples was made using the Esterification/Condensation Route, Option 1 (reaction times=4 to 12 hours) using esterification catalyst tetrabutyl titanate (0.03% TnBT).
Ex.1: 60 mol-% TPA, 40 mol-% IPA, 11.965 mol-% EG, 0.375 mol % HTPB
Tg (DSC)=65.1° C.
Relative viscosity (ASTM D 4603 Test Method)=1.048
Color b value (ASTM E1347 with ASTM D2244)=7.42

Ex.2: 40 mol-% TPA, 60 mol-% IPA, 119.625 mol-% EG, 0.375 mol % HTPB
Tg (DSC)=66.4° C.
Relative viscosity (ASTM D 4603 Test Method)=1.135
Color b value (ASTM E1347 with ASTM D2244)=12.25

Ex.3: 50 mol-% TPA, 50 mol-% IPA, 117 mol-% BDO, 2.5 mol % HTPB
Tg (DSC)=24.6° C.
Relative viscosity (ASTM D 4603 Test Method)=1.214

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A two-part masterbatch comprising:
a first part comprising an unsaturated thermoplastic polymer, wherein the first part has an iodine value of at least 10; and
a second part comprising an oxygen scavenging catalyst;
wherein the first and second parts are each in the form of separate solid particles, or the first part is in the form of solid particles and the second part is in the form of a liquid, and the first and second parts are combined in a masterbatch for forming a packaging article.

2. The masterbatch of claim 1 wherein the first part further comprises a non-cobalt-containing esterification catalyst.

3. The masterbatch of claim 1 wherein the unsaturated thermoplastic polymer comprises a polyester copolymer including unsaturated units.

4. The masterbatch of claim 1 wherein the first part comprises the unsaturated thermoplastic polymer in an amount of at least 25 wt-%, based on the weight of the first part.

5. The masterbatch of claim 1 wherein the unsaturated thermoplastic polymer comprises olefin structural units derived from an olefin or polyolefin selected from butadiene, polybutadiene, and a mixture thereof.

6. The masterbatch of claim 1 wherein the unsaturated thermoplastic polymer of the first part is derived from an olefin or a polyolefin in an amount of at least 0.5 wt-% and up to 25 wt-%, based on the weight of the first part.

7. The masterbatch of claim 1 wherein the oxygen scavenging catalyst comprises a metal, a complex of a metal, or a salt of a metal.

8. The masterbatch of claim 1 wherein the oxygen scavenging catalyst comprises a transition-metal-containing catalyst.

9. The masterbatch of claim 1 wherein the oxygen scavenging catalyst is present in an amount of at least 20 ppm and up to 2000 ppm (metal only), based on the total weight of the first and second parts.

10. The masterbatch of claim 1 wherein the second part further comprises a polyester diluent.

11. The masterbatch of claim 1 wherein the first part further comprises a polycondensate branching agent.

12. The masterbatch of claim 1 wherein the first part further comprises an antioxidant that also optionally functions as an olefin homopolymerization preventative.

13. The masterbatch of claim 1 wherein the first part comprises less than 50 ppm cobalt, if any.

14. The masterbatch of claim 1 comprising less than 5 wt-% of nylon-MXD6, if any.

15. A preform formed from the two-part masterbatch of claim 1.

16. A plastic container formed from the preform of claim 15.

17. The plastic container of claim 16 which is a plastic bottle.

18. A method of making a two-part masterbatch of claim 1, the method comprising:
providing a first part comprising an unsaturated thermoplastic polymer, wherein the first part has an iodine value of at least 10;
forming solid particles out of the first part;
providing a second part comprising an oxygen scavenging catalyst; and
forming solid particles or a liquid out of the second part;
combining the first and second parts to form a masterbatch for forming a packaging article.

19. A method of causing a packaging article to be made, the method comprising:
providing a two-part masterbatch of claim 1;
causing the masterbatch to be combined with a polyester diluent to form a mixture;
causing the mixture of the masterbatch and polyester diluent to be heated to a temperature of 250° C. to 290° C.;
causing the heated mixture to form a preform, free-standing film, or sheet; and
causing the preform, film, or sheet to be blown and/or stretched to form a packaging article.

20. A method of making a packaging article, the method comprising:
providing a two-part masterbatch of claim 1;
combining the masterbatch with a polyester diluent to form a mixture;
heating the mixture of the masterbatch and polyester diluent to a temperature of 250° C. to 290° C.;
forming a preform, free-standing film, or sheet out of the heated mixture; and
blowing and/or stretching the preform, film, or sheet to form a packaging article.
